(19) United States
(12) Patent Application Publication
(10) Pub. No.: US 2026/0320739 A1
(43) Pub. Date: Oct. 15, 2026

(54) IMAGE PROCESSING METHOD, IMAGE PROCESSING APPARATUS, IMAGE PROCESSING SYSTEM, AND STORAGE MEDIUM

(71) Applicant: CANON KABUSHIKI KAISHA, Tokyo (JP)

(72) Inventors: Yuichi KUSUMI, Tochigi (JP); Yoshiaki IDA, Saitama (JP); Yukino ONO, Tochigi (JP)

(21) Appl. No.: 19/558,561

(22) Filed: Mar. 6, 2026

(30) Foreign Application Priority Data
Apr. 14, 2025 (JP) 2025-066294

(51) Int. Cl. G06T 3/4046; G06T 3/4053; G06T 5/50; G06T 5/60; G06T 5/90; G06T 11/60

(52) U.S. Cl. CPC G06T 3/4046; G06T 3/4053; G06T 5/50; G06T 5/60; G06T 5/90; G06T 11/60; G06T 2207/20084; G06T 2207/20216

(57) ABSTRACT

An image processing method may include acquiring a first image corresponding to a first coordinate system and first information on scaling in a geometric transformation that converts the first coordinate system into a second coordinate system, generating a second image based on the first image using a machine learning model, and generating a fourth image based on second information on a weight based on the first information, the second image, and a third image based on the first image.

### BACKGROUND

### Field of the Technology

The present disclosure relates to an image processing method, an image processing apparatus, an image processing system, and a storage medium.

### Description of the Related Art

U.S. Pat. No. 11,055,819 discloses a method for upscaling an image using a machine learning model. Upscaling refers to image processing that estimates a high-frequency component that cannot be represented in a low-resolution image and generates a high-resolution image obtained by enlarging the image, and is also referred to as super-resolution.

Y. Zhang et al., “Toward Real-World Panoramic Image Enhancement,” 2020 IEEE/CVF Conference on Computer Vision and Pattern Recognition Workshops (CVPRW), 2020, pp. 2675-2684 discloses a method of generating a high-resolution equirectangular image (equidistant cylindrical projection) image by geometrically transforming an image captured by a fisheye lens into an equirectangular image and then applying a machine learning model that performs upscaling.

### SUMMARY

An image processing method according to one aspect of the present disclosure includes acquiring a first image corresponding to a first coordinate system and first information on scaling in a geometric transformation that converts the first coordinate system into a second coordinate system, generating a second image based on the first image using a machine learning model, and generating a fourth image based on second information on a weight based on the first information, the second image, and a third image based on the first image. An image processing apparatus corresponding to the image processing method, an image processing system including the image processing apparatus, and a storage medium storing a program that causes a computer to execute the above image processing method also constitute another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIGS. 1A-1D are diagrams for explaining scaling information according to a first embodiment.

FIG. 2 is a block diagram of an image processing system according to the first embodiment.

FIG. 3 is an external view of the image processing system according to the first embodiment.

FIG. 4 is a diagram illustrating a flow of a training phase according to the first embodiment.

FIG. 5 is a flowchart illustrating weight updating according to the first embodiment.

FIG. 6 is a diagram illustrating a flow of generating a fourth image according to the first embodiment.

FIG. 7 is a flowchart illustrating the generation of the fourth image according to the first embodiment.

FIG. 8 is a block diagram of an image processing system according to a second embodiment.

FIG. 9 is an external view of the image processing system according to the second embodiment.

FIG. 10 is a diagram illustrating a flow of generating a fourth image according to the second embodiment.

FIG. 11 is a flowchart illustrating the generation of the fourth image according to the second embodiment.

FIGS. 12A-12D are diagrams for explaining scaling information according to the second embodiment.

FIG. 13 is a diagram illustrating a flow of generating a fourth image according to the second embodiment.

FIG. 14 is a block diagram of an image processing system according to a third embodiment.

FIG. 15 is a flowchart illustrating generation of a fourth image according to the third embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the present disclosure. Corresponding elements in respective figures will be designated by the same reference numerals, and a duplicate description thereof will be omitted.

When an image captured by a fisheye lens is geometrically transformed into an equirectangular image, the degree of enlargement or reduction (scaling) caused by the geometric transformation differs between the horizontal direction and the vertical direction of the image. In addition, the scaling degree also varies according to a position within the image. That is, image quality is degraded due to scaling caused by the geometric transformation. In a case where an image in which direction-dependent scaling has occurred is upscaled using a machine learning model as disclosed in U.S. Pat. No. 11,055,819, overcorrection or undercorrection (insufficient correction) may occur according to the direction-dependent scaling. As the variations in image quality degradation associated with scaling increase, it becomes difficult to generate a high-resolution equirectangular image using the method disclosed in Y. Zhang et al., Toward Real-world Panoramic Image Enhancement, 2020 IEEE/CVF Conference on Computer Vision and Pattern Recognition Workshops (CVPRW), 2020, pp. 2675-2684. More specifically, since the machine learning model cannot distinguish between the structure of objects within the image and image quality degradation caused by the geometric transformation, overcorrection or undercorrection may occur in at least a part of the generated equirectangular image. For example, an object having a gradation-like appearance and an object in which sharpness has deteriorated due to enlargement of an object having weak gradation, such as edges, cannot be distinguished from each other.

Before describing specific examples, an overview of the present embodiment will be given. In the present embodiment, first, a first image and scaling information on scaling in a geometric transformation that converts a coordinate system representing the first image into a different coordinate system are obtained. Next, a machine learning model is used to generate an estimated image (a second image) based on the first image. Then, an output image (a fourth image) is generated based on weight information derived from the scaling information, the second image, and an image (a third image) that is different from the second image and is based on the first image. The third image includes the first image. The second image is an image having a greater number of pixels than the first image, or an image obtained by performing sharpening processing on the first image (an image in which sharpening components for the first image are estimated).

In the present embodiment, geometric transformation (coordinate transformation, remapping) refers to intentionally re-representing an image expressed in a predetermined coordinate system in a different coordinate system. For example, an image represented by an equidistant projection method is re-represented by an equirectangular projection for display on a head-mounted display (HMD). By the geometric transformation, objects in the image are spatially enlarged or reduced (scaled). Since the geometric transformation is a two-dimensional transformation, a scaling ratio can be independently set for each of a first direction and a second direction that are orthogonal to each other. The combination of the first direction and the second direction may be, for example, a combination of a horizontal direction and a vertical direction, or a combination of a radial direction and an azimuthal direction.

In the present embodiment, a coordinate system is a geometric representation method for placing an object in three-dimensional space on a two-dimensional plane, which is an image, and specifying its position. The coordinate system includes, in addition to projection methods used in mathematics and physics, map projection methods used in geography. Examples of the coordinate system include an equidistant projection, an equisolid-angle projection, an orthographic projection, a stereographic projection, a central projection, an equirectangular projection, and an azimuthal equidistant projection.

In the present embodiment, the scaling ratio indicates how much an object in an image after geometric transformation is enlarged or reduced relative to before the geometric transformation. For example, in a case where an object in the image after geometric transformation is represented with twice as many pixels in the horizontal direction as compared with before the geometric transformation, the scaling ratio in the horizontal direction is 2. In a case where it is represented with half as many pixels in the horizontal direction, the scaling ratio in the horizontal direction is ½. That is, a scaling ratio greater than 1 indicates enlargement, and a scaling ratio less than 1 indicates reduction.

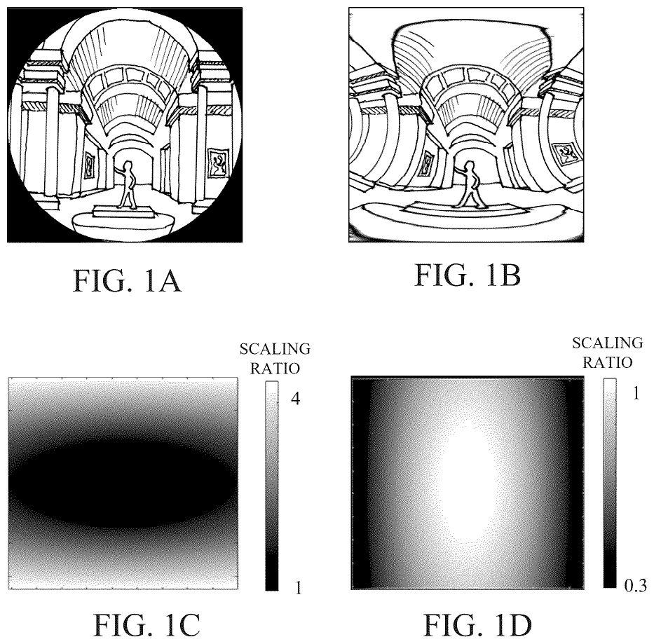

Before explaining the effects of the present embodiment, scaling by geometric transformation and characteristics of image quality degradation will be described. First, scaling by geometric transformation will be described. An object in an image undergoes different scaling in the first direction and the second direction due to the geometric transformation. That is, the scaling ratio in the first direction is different from the scaling ratio in the second direction. In addition, the scaling ratio also differs depending on the position at which the object is located. Therefore, the scaling ratio has variation in the first direction according to the position in the image, and has variation in the second direction that differs from that in the first direction. For example, a geometric transformation from an equidistant projection to an equirectangular projection will be described. FIGS. 1A-1D are diagrams for explaining scaling information. FIG. 1B is an image obtained by geometrically transforming FIG. 1A into an equirectangular projection in a case where FIG. 1A is regarded as an image represented by an equidistant projection. As illustrated in FIGS. 1A-1D, an object at a central portion of the image undergoes almost no scaling in either the horizontal direction or the vertical direction, whereas an object at upper and lower portions of the image is greatly enlarged only in the horizontal direction. Thus, the scaling ratio in the horizontal direction over the entire image has a wide variation that differs from that in the vertical direction. Thus, scaling by geometric transformation has variation according to the position and direction in the image.

In the present embodiment, image quality degradation caused by geometric transformation includes degradation of sharpness or aliasing noise. Degradation of sharpness occurs when the interval between sampling points in an image before geometric transformation is enlarged by the geometric transformation and resampling is performed. Aliasing noise occurs when the interval between sampling points in an image before geometric transformation is reduced by the geometric transformation and resampling is performed, thereby causing false structures that do not originally exist in the object to appear in the image.

In the present embodiment, scaling information on scaling in geometric transformation is represented by a ratio (enlargement ratio or reduction ratio) between corresponding shapes (line segments or areas) of images before and after geometric transformation. However, the scaling information on scaling is not limited to this example. For example, it may be represented by a moving amount from a point in the first image to a corresponding point in the geometrically transformed first image or the second image. The image deformation amount may differ according to the position in the image according to the geometric transformation method. In such a case, image quality degradation due to the geometric transformation also differs according to the position in the image. A pixel in an image refers to a region of the image corresponding to one pixel of an image sensor in an image pickup apparatus used to acquire the image. The scaling information on scaling may have scaling ratios for a plurality of different regions or a scaling ratio for each pixel in the first image.

When processing an image subjected to the above-described geometric transformation using a machine learning model, if there are large variations in scaling depending on direction or variations in image quality degradation accompanying scaling, image quality degradation such as overcorrection or undercorrection occurs. Such image quality degradation includes undercorrection or overcorrection, and also includes enhancement of artifacts or false structures generated by aliasing noise. In particular, in a case where scaling by geometric transformation is large or in a case where differences in scaling depending on direction are large, the above-described image quality degradation tends to increase. In addition, in a case where an image processed by a machine learning model is geometrically transformed, image quality degradation occurs due to scaling in the geometric transformation. In this case, the image quality degradation includes degradation of sharpness due to enlargement and aliasing noise (generation of false structures) due to reduction.

The present embodiment generates an image in which the effect of the machine learning model is adjusted based on the scaling information, by generating the fourth image based on weights based on scaling information in the geometric transformation, the second image generated by the machine learning model, and the third image. That is, since the above-described image quality degradation is caused by scaling due to geometric transformation, adjusting the effect of the machine learning model and the sharpness of the image based on the scaling information can suppress image quality degradation without reducing overall sharpness. Thus, it is possible to suppress image quality degradation that occurs when an image subjected to geometric transformation is processed by a machine learning model, as well as image quality degradation that occurs when an image processed by a machine learning model is geometrically transformed.

In the present embodiment, the machine learning model is generated by performing training using a neural network. The machine learning model may be learned using genetic programming, a Bayesian network, or the like. As the neural network, for example, a Convolutional Neural Network (CNN) or a Generative Adversarial Network (GAN) may be adopted. A Recurrent Neural Network (RNN) or the like may also be adopted. In the neural network, filters for convolution with an image, biases to be added, and activation functions for nonlinear transformation are used. The filters and biases are referred to as weights and are updated (learned) using training images and ground-truth images. In the present embodiment, this processing will be referred to as a training phase. The image processing method according to the present embodiment generates an estimated image (the second image) based on the first image and the machine learning model. Processing is performed to generate an output image (the fourth image) based on weight information based on scaling information on scaling in geometric transformation, the second image, and the third image. In the present embodiment, this processing will be referred to as an inference phase. The above-described image processing method is merely an example, and the present disclosure is not limited to this example. Details of other image processing methods and the like will be described in the following examples.

### First Embodiment

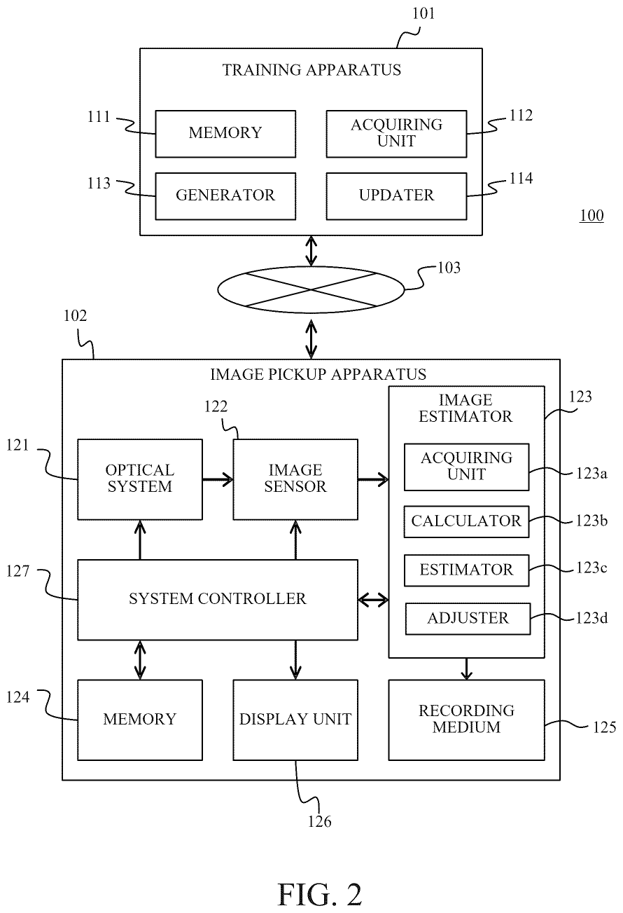

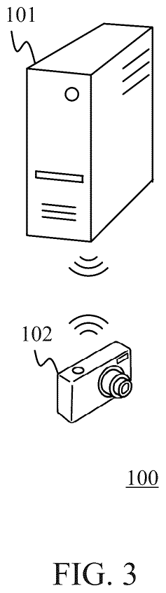

In the present embodiment, a machine learning model is trained and executed to perform upscaling processing that generates a high-resolution image obtained by enlarging an image. FIG. 2 is a block diagram of an image processing system 100 according to the present embodiment, and FIG. 3 is an external view of the image processing system 100. The image processing system 100 includes a training apparatus 101 and an image pickup apparatus 102. The training apparatus 101 and the image pickup apparatus 102 are connected to each other via a wired or wireless network 103.

The training apparatus 101 includes a memory 111, an acquiring unit 112, a generator 113, and an updater 114, and is configured to determine weights of the machine learning model.

The image pickup apparatus 102 includes an optical system 121, an image sensor 122, an image estimator (image processing apparatus) 123, a memory 124, a recording medium 125, a display unit 126, and a system controller 127. The optical system 121 is configured to collect light incident from an object space and to form an object image. The optical system 121 may have functions such as zooming, aperture adjustment, and autofocus (AF), as needed. The image sensor 122 is configured to convert an object image formed by the optical system 121 into an electrical signal to generate an original image. The image sensor 122 is, for example, a Charge Coupled Device (CCD) sensor or a Complementary Metal-Oxide Semiconductor (CMOS) sensor.

In the present embodiment, the optical system 202a includes a fisheye lens employing an equidistant projection method, and an object in an input image is represented in the equidistant projection method. However, the optical system 202a is not limited to this example, and an optical system employing any projection method may be used.

The image estimator 123 includes an acquiring unit 123a, a calculator 123b, an estimator 123c, and an adjuster 123d. In addition, the image estimator 123 includes one or more memories storing instructions, and one or more processors that, upon execution of the instructions, operate to serve as the acquiring unit 123a, the calculator 123b, the estimator 123c, and the adjuster 123d. For example, the one or more processors can operate to acquire a first image and first information on scaling in a geometric transformation that converts a coordinate system representing the first image into a different coordinate system, generate a second image based on the first image using a machine learning model, and generate a fourth image based on second information based on the first information, the second image, and a third image that is different from the second image and based on the first image. The image estimator 123 is configured to acquire an input image (a first image), geometrically transform the first image, and generate, from the geometrically transformed first image, an estimated image (a second image) that has been subjected to upscaling processing using the machine learning model. The image estimator 123 is further configured to generate an output image (a fourth image) in which an effect of the machine learning model is adjusted, based on the estimated image (the second image), an image (a third image) based on the geometrically transformed first image, and weight information based on scaling information on the geometric transformation. The output image is an image in which degradation in image quality caused when the geometrically transformed first image is processed by the machine learning model is suppressed. Here, the image based on the first image is an image obtained by interpolating and enlarging the geometrically transformed first image, and corresponds to the third image.

The geometric transformation in the present embodiment is a transformation from a coordinate system represented by the equidistant projection method to a coordinate system represented by an equirectangular projection. However, the present disclosure is not limited to this example, and may use an image represented by any projection method, or a transformation to an image represented by any projection method.

Weight information on a multilayer neural network serving as the machine learning model is generated by the training apparatus 101. The image pickup apparatus 102 reads the weight information from the memory 111 via the network 103 in advance and stores the weight information in the memory 124. The stored weight information may be numerical values of the weights themselves or may be in an encoded form. Details of updating the weights and generating the estimated image using the weights will be described later. The image estimator 123 may be configured to generate the output image by performing development processing and other image processing, as needed. The image estimator 123 may be implemented using a processor in the image pickup apparatus 102, an external apparatus, or another storage medium.

The recording medium 125 records the output image. In a case where a user issues an instruction to output the output image, the display unit 126 displays the output image. The above operations are controlled by the system controller 127.

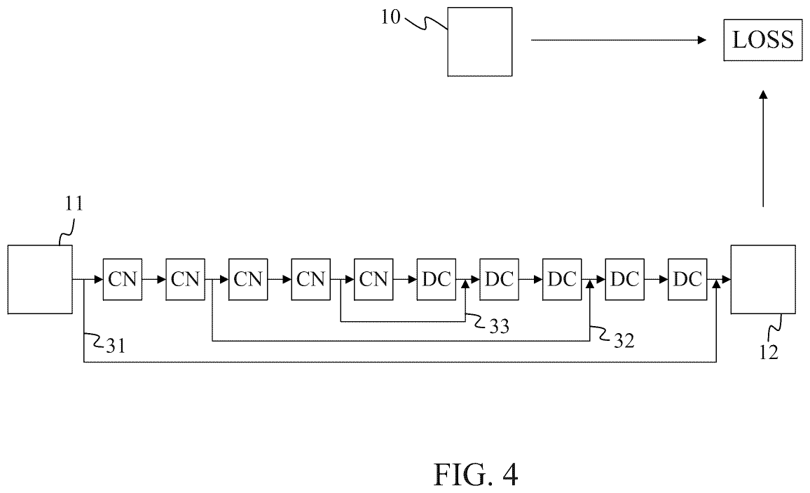

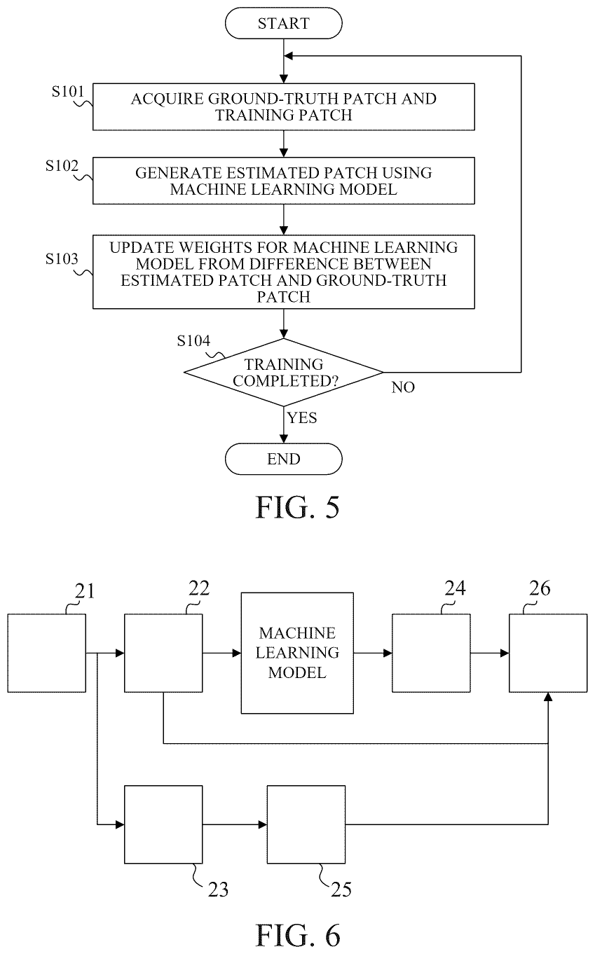

Next, a method of updating weights (a method of manufacturing a trained model) executed by the training apparatus 101 according to the present embodiment will be described with reference to FIGS. 4 and 5. FIG. 4 illustrates a flow of a training phase, and FIG. 5 is a flowchart illustrating weight updating. Each step in FIG. 5 is mainly executed by the acquiring unit 112, the generator 113, and the updater 114.

In step S101, the acquiring unit 112 acquires a ground-truth patch 10 and a training patch 11. The ground-truth patch 10 and the training patch 11 are generated by the generator 113. A patch refers to an image having a predetermined number of pixels (such as 64×64 pixels). Generation of the ground-truth patch and the training patch will be described later.

In step S102, the generator 113 inputs the training patch 11 to a multilayer neural network and generates an estimated patch 12. The estimated patch 12 is an image obtained from the training patch 11 by the machine learning model, and ideally matches the ground-truth patch 10. In convolution layers CN and deconvolution layers DC, convolution between an input and a filter and summation with a bias are calculated, and a result is processed by an activation function. Initial values of components of the filters and the biases are arbitrary and are determined by random numbers in the present embodiment. The activation function may be, for example, a Rectified Linear Unit (ReLU) or a sigmoid function. Outputs of respective layers except for a final layer are referred to as feature maps. Skip connections 32 and 33 combine feature maps output from non-consecutive layers. Combination of feature maps may be performed by element-wise summation or by concatenation in a channel direction. In the present embodiment, element-wise summation is employed. A skip connection 31 generates the estimated patch by taking a sum of an estimated residual between the training patch and the ground-truth patch and the training patch.

Although the neural network configuration illustrated in FIG. 4 is used in the present embodiment, the present disclosure is not limited to this example. In a case where training a machine learning model that upscales an image as in the present embodiment, a patch obtained by interpolating and enlarging the training patch may be input to the neural network. An output of the neural network may be a residual patch corresponding to an additional component with respect to the interpolated and enlarged training patch before the skip connection 31. The residual patch represents a sharpening component for the interpolated and enlarged training patch. The neural network may include a layer configured to enlarge feature maps, and may output an estimated patch having a larger number of pixels than the input training patch. In such a case, a patch obtained by interpolating and enlarging the training patch is used for the skip connection 31.

In step S103, the updater 114 updates the weights of the neural network based on an error between the estimated patch 12 and the ground-truth patch 10. In the present embodiment, the weights include components of filters of respective layers and biases. Backpropagation is used for updating the weights, although the present disclosure is not limited to this example. In mini-batch training, errors between a plurality of ground-truth patches and corresponding estimated patches are calculated to update the weights. As a loss function, for example, an L2 norm or an L1 norm may be used, but the present disclosure is not limited to this example, and online training or batch training may also be used.

In step S104, the updater 114 determines whether weight updating has been completed. Completion of weight updating may be determined based on whether the number of iterations of weight updating has reached a predetermined number or whether a weight change amount during updating is smaller than a predetermined value. In a case where it is determined that weight updating has not been completed, the flow returns to step S101, and the acquiring unit 112 acquires one or more new sets of ground-truth patches and training patches. In a case where it is determined that weight updating has been completed, the updater 114 ends training and stores the weight information in the memory 111.

Hereinafter, a method of generating training data will be described. The training data include a ground-truth patch 10 and a training patch 11, and are mainly generated by the generator 113.

First, the generator 113 acquires ground-truth images and training images from the memory 111. The ground-truth images include a plurality of images, and may be images acquired by the image pickup apparatus 102 or Computer Graphics (CG) images. The ground-truth images may have sufficient high-frequency components because weights of the machine learning model are determined so as to enable estimation of images having sufficient high-frequency components and high perceived resolution. For example, in a case where the ground-truth images are captured images, the ground-truth images may be images captured using an optical system having higher performance than the optical system 121, or images obtained by downscaling captured images. The ground-truth images may be represented in grayscale or may have a plurality of channel components. By using ground-truth images obtained by imaging various objects, robustness of the machine learning model for a variety of objects can be improved. For example, the ground-truth images may include images having edges, textures, gradations, and flat regions with various intensities and directions. Information on an optical system corresponding to the ground-truth images may be stored in the memory 111, as needed.

Next, training images are generated. The training images include a plurality of images, and may be captured images or CG images. In the present embodiment, the number of pixels of each training image is smaller than that of the corresponding ground-truth image, and a ratio between the number of pixels of the training image and the number of pixels of the ground-truth image is equal to a ratio between the number of pixels of the first image and the number of pixels of the second image. Each training image includes the same object as the corresponding ground-truth image and has a larger sampling pitch than that of the ground-truth image. The training images may include image quality degradation having an intensity comparable to that of the first image. Image quality degradation includes, for example, jaggies in contours or edges, spatial aliasing, compression artifacts, and noise. Thereby, robustness of the machine learning model with respect to image quality degradation included in the first image can be improved.

The training images may be generated using the ground-truth images. For example, training images may be generated by downscaling the ground-truth images and applying image quality degradation corresponding to that of the first image. Alternatively, ground-truth images and training images may be generated using images different from the ground-truth images and training images.

In a case where the ground-truth images and the training images are generated using captured images, images captured by the optical system 121 and the image sensor 122 may be used. For example, such captured images may be used as training images. The ground-truth images may be obtained by capturing the same object as the training images using the image sensor having a smaller sampling pitch than that of the image sensor 122. The ground-truth images may be captured using an optical system having fewer aberrations than the optical system 121. Thereby, since the ground-truth images become higher-resolution images, a more accurate estimated image (the second image) can be generated in an estimation phase.

Finally, the ground-truth patch 10 and the training patch 11 are generated. The ground-truth patch and the training patch are generated by extracting images having a predetermined number of pixels from regions indicating the same object in the ground-truth image and the training image, respectively. The ground-truth image and the training image themselves may be used as the ground-truth patch and the training patch.

In a case where the first image is a moving image, the ground-truth images and the training images may be generated from a plurality of moving images. At the same time, in step S102, when the machine learning model generates an output patch from a training patch, another training patch temporally adjacent to the training patch may also be used. Thereby, when generating a second image (moving image) by processing a specific frame of the first image (moving image), information on an object, which does not exist in the frame, can be interpolated using temporally adjacent frames, thereby possibly obtaining a pixel-shift super-resolution effect. For example, in a case where an object in the frame is sampled with a half-pixel shift in another temporally adjacent frame, twice the amount of high-frequency information on the object can be obtained. Thereby, the image quality of the second image (moving image) generated by inputting the first image to the machine learning model may be improved.

In a case where the first image is a geometrically transformed image as in the present embodiment, the ground-truth images and the training images may be images represented in a geometrically transformed coordinate system. In a case where the training images are geometrically transformed images, the machine learning model can perform training that considers image quality degradation caused by geometric transformation. The ground-truth images may be images represented in a geometrically transformed coordinate system and have less image quality degradation caused by geometric transformation. In a case where the training images are geometrically transformed images, processing corresponding to image quality degradation caused by geometric transformation can be performed by inputting scaling information on the geometric transformation to the machine learning model. In this case, scaling information on the geometric transformation described later is generated for the training images, and scaling information patches may be generated and used similarly to the ground-truth patches and the training patches. By training the machine learning model using the above training data, training that considers geometric transformation can be performed. However, in a case where there are many variations of image quality degradation caused by geometric transformation, highly accurate processing becomes difficult. In a case where image quality degradation caused by geometric transformation is large, processing difficulty increases and highly accurate processing becomes difficult.

The present embodiment trains and uses a machine learning model for upscaling an image. However, the present disclosure is not limited to this example, and machine learning models for a variety of tasks may be trained and used. For example, when generating an image having reduced blur and increased sharpness from an image, patches having blur are acquired as training images and corresponding patches having less blur are acquired as ground-truth images, and the machine learning model is trained and used. For other tasks as well, the machine learning model may be trained by acquiring patches corresponding to inputs as training images and patches corresponding to outputs as ground-truth images.

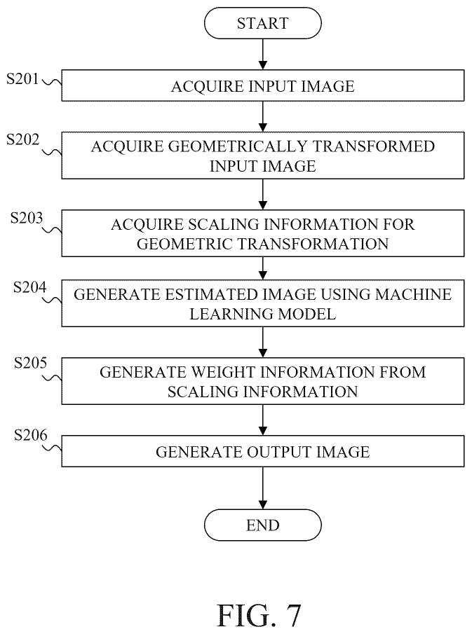

Next, an image processing method (estimation phase) using the trained machine learning model will be described. FIG. 6 illustrates a flow of generating a fourth image (estimation phase) according to the present embodiment, and FIG. 7 is a flowchart illustrating the generation of the fourth image. Each step in FIG. 7 is executed by the acquiring unit 123a, the calculator 123b, the estimator 123c, and the adjuster 123d.

In step S201, the acquiring unit 123a acquires an input image (a first image) 21. In the present embodiment, the input image (the first image) 21 is an image captured by the optical system 121 and the image sensor 122 and is represented using an equidistant projection method. The optical system 121 uses a fisheye lens and employs the equidistant projection method.

With reference to FIG. 1A, the equidistant projection method will be described. In the equidistant projection method, an object in a three-dimensional space is disposed on an image at a distance proportional to a zenith angle θ with respect to a reference point O on the image. In FIG. 1A, an image plane is an XY plane, and pixel array directions of the image are a horizontal direction (X-axis) and a vertical direction (Y-axis), respectively. In this case, according to the following equations (1) and (2), an object in the three-dimensional space is disposed on the image by the optical system 121 employing the equidistant projection method.

x=f×θ×cos φ (1)

y=f×θ×sin φ (2)

In equations (1) and (2), x denotes a horizontal coordinate and y denotes a vertical coordinate with respect to the reference point O (center of an optical axis) on the image. Further, f denotes a focal length of the optical system 121, θ denotes an angle (zenith angle) of the object with respect to the optical axis, and φ denotes a horizontal angle of the object with respect to the reference point O. In the present embodiment, the zenith angle θ represents an angle between a Z-axis (optical axis) and a straight line from the reference point O to the object. The horizontal angle φ represents an angle between the X-axis and a straight line obtained by projecting, onto the image plane XY, a straight line from the reference point O to the object. The input image may be represented in grayscale or may have a plurality of channel components. The input image may be a portion of an entire captured image.

In step S202, the calculator 123b converts the input image (the first image) 21 into a first image 22 represented using an equirectangular projection by geometric transformation.

With reference to FIG. 1B, the equirectangular projection will be described. The equirectangular projection is a map projection method in which an object on a three-dimensional spherical surface is disposed on an image at a vertical distance proportional to a latitude α and a horizontal distance proportional to a longitude β. In FIG. 1B, similarly to FIG. 1A, the image plane is an XY plane. In this case, when the equirectangular projection is used, an object on the three-dimensional spherical surface is disposed on the image according to the following equations (3) and (4).

x=R×β (3)

y=R×α (4)

In equations (3) and (4), x denotes a horizontal coordinate and y denotes a vertical coordinate with respect to the reference point O on the image. R denotes a radius of a sphere on which the object exists. In the present embodiment, the latitude α represents an angle between an equatorial plane (XZ plane) and a straight line from the reference point O to the object. The longitude β in the present embodiment represents an angle between the Z-axis and a straight line obtained by projecting, onto the equatorial plane (XZ plane), a straight line from the reference point O to the object.

For geometric transformation, first, based on a relationship between the equidistant projection method corresponding to a coordinate system of the input image (the first image) and the equirectangular projection corresponding to a coordinate system after geometric transformation, a relationship between respective pixels in images before and after geometric transformation is calculated. That is, pixels of the input image (the first image) before the geometric transformation corresponding to respective pixels of the geometrically transformed first image are calculated. The number of pixels of the corresponding input image (first image) is one or more. Next, using an interpolation method such as nearest-neighbor interpolation, bilinear interpolation, or bicubic interpolation, pixel values of the geometrically transformed first image are calculated based on pixel values of the input image (the first image).

In step S203, the calculator 123b generates scaling information 23 on the geometric transformation performed in step S202. The scaling information 23 represents a deformation amount applied when generating the geometrically transformed first image 22 in step S202. In the present embodiment, the scaling information 23 includes two types of two-dimensional maps indicating scaling ratios in a horizontal direction and a vertical direction associated with conversion (geometric transformation) from the equidistant projection method to the equirectangular projection. Here, the scaling information 23 will be described with reference to FIGS. 1A-1D. FIG. 1A illustrates an example of the input image (the first image) 21 represented using the equidistant projection method. FIG. 1B illustrates an example of the first image 22 represented using the equirectangular projection after geometric transformation. FIG. 1C illustrates a two-dimensional map indicating a horizontal scaling ratio when the first image 22 is generated from the input image (the first image) 21 by geometric transformation. FIG. 1D illustrates a two-dimensional map indicating a vertical scaling ratio when the first image 22 is generated from the input image (the first image) 21 by geometric transformation. In the present embodiment, the two types of two-dimensional maps illustrated in FIGS. 1C and 1D correspond to the scaling information 23.

The scaling information 23 is information represented by scalar values or two-dimensional maps (feature maps), and indicates a deformation amount of corresponding shapes between the input image (the first image) and the geometrically transformed first image. The deformation amount may be obtained at a plurality of positions. That is, the scaling information may be a two-dimensional map having values that vary depending on image position. The shape may be, for example, a distance between two corresponding points (a line segment) in the input image (the first image) and the geometrically transformed first image, or an area of a corresponding region. In a case where the deformation amount is represented as a ratio, it may be represented by a scaling ratio that becomes greater than 1 as enlargement increases and becomes less than 1 as reduction increases. The deformation amount of the image may also be represented using a difference (change amount) between corresponding shapes in images before and after geometric transformation. The deformation amount may be represented using a moving amount from one point in the input image (the first image) to a corresponding point in the geometrically transformed first image, and the deformation amount corresponds to information about image scaling.

The scaling information in the present embodiment includes two types or more two-dimensional maps indicating scaling ratios in mutually different directions. More specifically, the scaling information in the present embodiment is represented by two types of two-dimensional maps corresponding to horizontal and vertical directions, which are pixel array directions. The scaling ratio in the horizontal direction is a value calculated using a distance between two arbitrary points in the horizontal direction in the geometrically transformed first image and a distance between two corresponding points in the horizontal direction in the input image (the first image). The two-dimensional map in the horizontal direction is generated by obtaining a plurality of deformation amounts based on a distance between arbitrary different pairs of points in the input image (the first image) and the geometrically transformed first image. Similarly, the two-dimensional map in the vertical direction can be generated in a similar manner.

Although examples of two types of two-dimensional maps indicating scaling ratios in the horizontal direction and the vertical direction have been described, the scaling information may indicate scaling in a plurality of mutually different directions. For example, the scaling information may indicate scaling in two directions inclined by 45 degrees and 135 degrees relative to the horizontal direction, or may indicate scaling in a concentric direction and a radial direction.

Steps S202 and S203 in the present embodiment may be processed simultaneously. In a case where a plurality of geometrically transformed first images 22 are generated using a plurality of input images (the first images) 21 in step S202, a plurality of pieces of scaling information 23 may be obtained.

The image estimator 123 may be included in an image processing apparatus different from the image pickup apparatus 102. In such a case, an image acquired by the acquiring unit 123a may be an image corresponding to the geometrically transformed first image 22 rather than the input image (the first image) 21. That is, step S202 may be performed in advance by an image processing apparatus different from the image estimator 123, and the geometrically transformed first image 22 may be generated from the input image (the first image) 21.

In step S204, the estimator 123c generates an estimated image (a second image) 24 by inputting the geometrically transformed first image 22 to the machine learning model. The second image 24 is an image obtained by upscaling the geometrically transformed first image 22. In a case where the machine learning model is configured to receive scaling information on geometric transformation, the estimated image (the second image) 24 is generated by inputting the geometrically transformed first image 22 and the scaling information 23 to the machine learning model.

The estimated image obtained here may suffer from image quality degradation due to differences in scaling in respective directions caused by geometric transformation and due to a wide variety of scaling. For example, in regions enlarged by geometric transformation, artifacts may occur due to undercorrection or overcorrection, and in regions reduced by geometric transformation, false structures generated in the first image by geometric transformation may be emphasized. Such image quality degradation tends to occur more strongly in regions where scaling by geometric transformation is large. That is, image quality degradation tends to be stronger in regions where enlargement or reduction caused by geometric transformation is large. Even when training is performed using training data including geometric transformation or when the machine learning model is configured to receive scaling information on geometric transformation, processing can be performed while the scaling of geometric transformations is considered, but image quality degradation similarly tends to increase in regions where enlargement or reduction is large.

A residual image corresponding to a sharpening component obtained by machine learning may be generated as the estimated image (the second image). Even when the residual image is generated as the estimated image (the second image), the estimated image similarly includes components that cause the above-described image quality degradation.

In step S205, the adjuster 123d acquires weight information 25 based on the scaling information 23. The weight information 25 is a weight used to calculate a weighted average of an image (a third image) based on the geometrically transformed first image and the second image, and is a weight used to adjust an effect of processing by the machine learning model. In a case where a residual image is generated as the estimated image (the second image), the weight information corresponds to a weight for the residual image, and is used for performing weighted addition of the image (the third image) based on the geometrically transformed first image and the second image. The weight information 25 is a two-dimensional map corresponding to each pixel of the second image, similarly to the scaling information 23. Here, the third image is an image obtained by interpolating and enlarging the geometrically transformed first image, and is an image based on the first image.

As described above, since image quality degradation in the second image tends to increase in regions where enlargement or reduction caused by geometric transformation is large, the weight information 25 may be based on the scaling information 23 of geometric transformation. More specifically, the weight of the second image may reduce in regions where enlargement or reduction caused by geometric transformation is large. That is, the weight of the second image may be small in regions where enlargement is large, the weight of the second image is small in regions where reduction is large, and the weight of the second image is large when enlargement or reduction is small. That is, in a case where, in geometric transformation, a first scaling ratio is greater than 1 and a second scaling ratio is greater than the first scaling ratio, a weight of a region of the second image corresponding to the second scaling ratio is smaller than a weight of a region of the second image corresponding to the first scaling ratio. In a case where, in geometric transformation, a first scaling ratio is smaller than 1 and a second scaling ratio is smaller than the first scaling ratio, a weight of a region of the second image corresponding to the second scaling ratio is smaller than a weight of a region of the second image corresponding to the first scaling ratio.

Since scaling caused by geometric transformation varies depending on image position, the weight information 25 based on the scaling information may also vary according to image position.

The weight information 25 may be generated based on scaling information in at least one direction. In a case where an image represented using the equidistant projection method is converted into an image represented using the equirectangular projection as in the present embodiment, the image is enlarged in the horizontal direction and reduced in the vertical direction. Therefore, the weight information 25 may be generated based on the scaling ratio in the horizontal direction, in which image quality degradation (reduction in sharpness) occurs due to enlargement. Alternatively, the weight information 25 may be generated based on the scaling ratio in the vertical direction, in which image quality degradation (generation of a false structure) occurs due to reduction, or may be generated based on both the horizontal and vertical scaling ratios. In a case where the weight information 25 is generated based on both the horizontal and vertical scaling ratios, the weight information 25 may be generated based on a larger scaling ratio of the scaling ratios in respective directions, or weight information 25 for each direction may be generated based on the scaling ratio in each direction. In a case where weight information for each direction is generated, weight information adopting a smaller one of the weights for the second image among the respective directions may be generated.

In a case where priority is given to suppression of image quality degradation caused by processing a geometrically transformed image using the machine learning model, weights corresponding to directions having large enlargement or reduction may be adopted so as to reduce the weight of the second image, as described above. On the other hand, in a case where priority is given to an effect of the machine learning model, weights corresponding to directions having small enlargement or reduction may be adopted.

The weight information 25 may be generated based on a ratio between two pieces of scaling information in mutually different directions. In regions where the ratio between scaling ratios in the respective directions is large, a weight corresponding to the second image may be reduced. That is, in a case where a ratio between two scaling ratios in mutually different directions caused by geometric transformation is a second ratio that is larger than a first ratio, a weight of a region of the second image corresponding to the second ratio is smaller than a weight of a region of the second image corresponding to the first ratio. Here, the ratio between scaling ratios in the respective directions is a value obtained by dividing a larger scaling ratio by a smaller scaling ratio among the scaling ratios in the respective directions, and is represented by a ratio of 1 or more, indicating a magnitude of a difference between scaling ratios in the respective directions. As in the present embodiment, in a case where an image represented using an equidistant projection method is converted into an image represented using an equirectangular projection, the image is enlarged in a horizontal direction and reduced in a vertical direction. Therefore, the weight of the second image is reduced in regions where the ratio of scaling between the horizontal direction and the vertical direction is large. Thereby, image quality degradation caused by overcorrection or undercorrection can be suppressed, which occurs when the first image, in which different scaling occurs in different directions due to geometric transformation, is processed by a machine learning model.

In step S206, the adjuster 123d generates an output image (a fourth image) 26 based on the geometrically transformed first image (a third image) 22, the second image 24, and the weight information 25. More specifically, based on the weight information 25 obtained in step S205, a weighted average of the third image and the second image 24 is calculated. Here, the third image is an image obtained by interpolating and enlarging the geometrically transformed first image 22, and is an image based on the first image. Calculating a weighted average of the third image and the second image using the weight information based on geometric transformation can suppress image quality degradation that occurs when a geometrically transformed image is processed by a machine learning model.

In a case where a residual image is generated as the estimated image (the second image), the output image (the fourth image) 26 is generated by performing a weighted addition of the third image and the second image 24 based on the weight information 25. That is, the output image (the fourth image) 26 is generated by applying the weight information 25 to the second image 24 and adding the weighted second image to the third image.

As in the present embodiment, in a case where the geometrically transformed first image is upscaled by a machine learning model to generate the second image, an image (the third image) obtained by interpolating and enlarging the geometrically transformed first image so as to have the same number of pixels as that of the second image and the second image are subjected to weighted averaging or weighted addition. That is, the fourth image is generated based on the second image, the third image, and the weight information. The third image is the first image or an image that is based on the first image and is different from the second image. In the present embodiment, the third image is an image obtained by geometrically transforming and interpolating the first image. In a case where the machine learning model reduces image blur, the third image may be the geometrically transformed first image.

In a case where weight information is generated for each of the horizontal and vertical directions in step S205, weighted averaging or weighted addition may be performed for each of horizontal components and vertical components of the third image and the second image. In that case, sub-band images for each direction and frequency band may be generated by performing frequency decomposition, such as wavelet transformation, on the third image and the second image, weighted averaging may be performed for each directional sub-band image using corresponding weight information, and inverse transformation may be performed to generate the fourth image. In a case where the second image is a residual image, inverse transformation may be performed after applying corresponding weight information to each sub-band image obtained by frequency decomposition of the second image, and the resulting image may be added to the third image.

The present embodiment uses an image obtained by interpolating and enlarging the geometrically transformed first image, as the third image, but the third image may be an image that is based on the first image and is different from the second image. For example, the second image may be generated by inputting the geometrically transformed first image to a first machine learning model, and the third image may be generated by inputting the geometrically transformed first image to a second machine learning model, and the second image and the third image may be weighted-averaged based on the weight information. That is, the third image may be generated using a machine learning model different from the machine learning model used to generate the second image. In this case, the first machine learning model may be a model having a stronger processing effect than that of the second machine learning model. For example, the first machine learning model may be a GAN, and the second machine learning model may be a CNN trained using a loss function based only on an error between a ground-truth image and an estimated image. Alternatively, a configuration may be adopted in which a single machine learning model outputs two images having different sharpness levels, and an image having higher sharpness is used as the second image, while the other image is used as the third image.

As described above, the configuration according to the present embodiment can suppress image quality degradation that occurs when an image subjected to geometric transformation is processed by a machine learning model.

### Second Embodiment

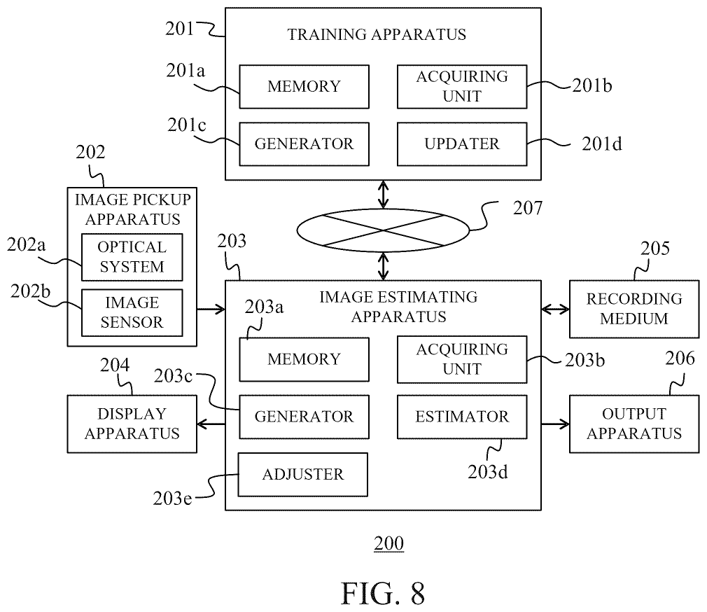

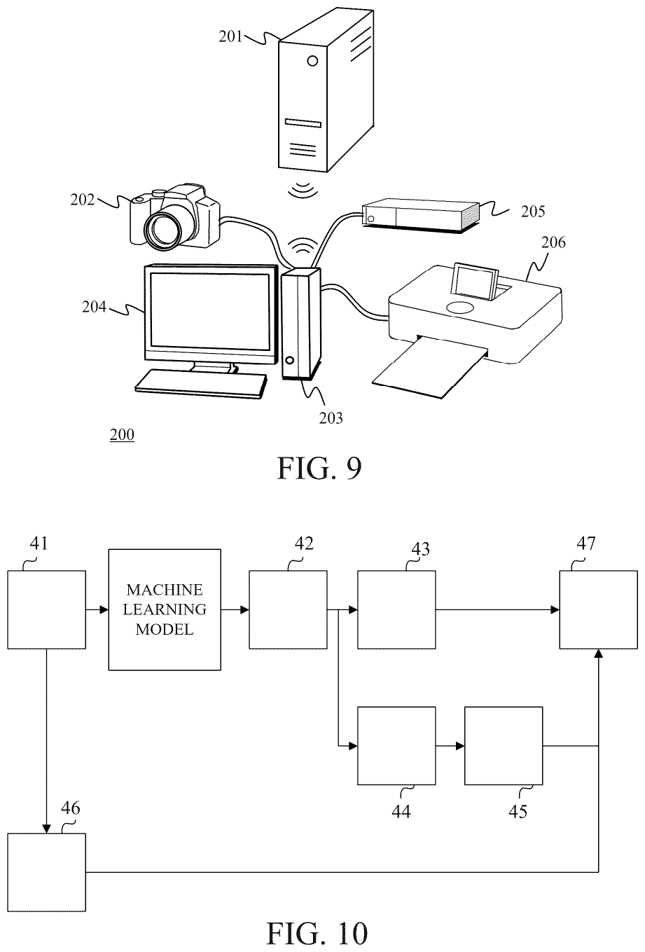

The present embodiment causes a machine learning model to train and execute processing for reducing image blur and sharpening the image. An image processing system 200 according to the present embodiment differs from that of the first embodiment in that the image processing system 200 acquires an input image from an image pickup apparatus 202 and performs image processing by an image estimating apparatus (image processing apparatus) 203. FIG. 8 is a block diagram of the image processing system 200. FIG. 9 is an external view of the image processing system 200. The image processing system 200 includes a training apparatus 201, the image pickup apparatus 202, the image estimating apparatus 203, a display apparatus 204, a recording medium 205, an output apparatus 206, and a network 207.

The training apparatus 201 includes a memory 201a, an acquiring unit 201b, a generator 201c, and an updater 201d, and determines weights of the machine learning model.

The image pickup apparatus 202 includes an optical system 202a and an image sensor 202b, and acquires an input image (a first image). The optical system 202a collects light incident from an object space and forms an object image. The image sensor 202b converts the object image formed by the optical system 202a into an electrical signal to generate the input image (the first image). In the present embodiment, the optical system 202a includes a fisheye lens adopting an equisolid angle projection method, and an object in the first image has distortion corresponding to the equisolid angle projection method. However, the optical system 202a is not limited to this example, and an optical system adopting any projection method may be used.

The image estimating apparatus 203 includes a memory 203a, an acquiring unit 203b, a generator 203c, an estimator 203d, and an adjuster 203e. The image estimating apparatus 203 generates an estimated image (a second image) using the machine learning model. The image estimating apparatus 203 acquires the input image (the first image) and generates a blur-reduced estimated image (the second image) using the machine learning model. The image estimating apparatus 203 geometrically transforms the second image, and generates an output image (a fourth image) in which an effect of the machine learning model is adjusted, based on a geometrically transformed first image (a third image), the geometrically transformed second image, and weights based on scaling information on the geometric transformation. The output image is an image in which image quality degradation caused when the second image generated by the machine learning model is geometrically transformed is suppressed. Alternatively, the image estimating apparatus 203 may generate the output image (the fourth image) in which the effect of the machine learning model is adjusted, by geometrically transforming a fifth image generated based on the first image (the third image), the second image, and weights based on the scaling information on the geometric transformation.

The geometric transformation in the present embodiment is a transformation from a coordinate system represented by an equisolid angle projection method to a coordinate system represented by a central projection method. However, the present embodiment is not limited to this example, and images represented by an arbitrary projection method or representation method may be used. Information on the weights of the machine learning model is generated by the training apparatus 201. The image estimating apparatus 203 reads the weight information from the memory 201a via the network 207 and stores the weight information in the memory 203a. Updating of the weights performed by the training apparatus 201 is similar to that of the training apparatus 101 of the first embodiment, and thus a description thereof will be omitted. Details of generation of training data and image processing using the weights will be described later. The image estimating apparatus 203 may further include a function of generating an output image by performing development processing or other image processing, as necessary.

The output image generated by the image estimating apparatus 203 is output to at least one of the display apparatus 204, the recording medium 205, and the output apparatus 206. The display apparatus 204 includes, for example, a liquid crystal display, a projector, or the like. The display apparatus 204 may allow a user to perform editing operations while checking an image being processed. The recording medium 205 includes, for example, a semiconductor memory, a hard disk drive, or a server on a network, and stores the output image. The output apparatus 206 includes, for example, a printer.

A recording medium 125 records the output image. In a case where an instruction to output the output image is given by a user, a display unit 126 displays the output image. The above operations are controlled by a system controller 127.

Next, a method for generating training data will be described. The training data include ground-truth patches and training patches, and are mainly generated by the generator 201c. The step for generating training data for training the machine learning model in the present embodiment is similar to the generating step in the first embodiment, but the number of pixels of the training image and the number of pixels of the ground-truth image are the same, and the number of pixels of the training patch and the number of pixels of the ground-truth patch are also the same. In the present embodiment, the training image is an image including the same blur as that of the first image. Thereby, the machine learning model can acquire a function of correcting blur included in the first image. Thus, the blur included in the training image may be blur based on an optical system used to capture the input image (the first image), such as blur caused by a diffraction phenomenon based on the optical system.

The present embodiment trains and uses a machine learning model for generating a blur-reduced image from an image, but the present disclosure is not limited to this example, and machine learning models for various tasks may be trained and used. For example, in generating a noise-reduced image from an image, patches including noise may be acquired as training images and corresponding patches with less noise may be acquired as ground-truth images to train and use the machine learning model. For other tasks as well, training may be performed by acquiring patches corresponding to inputs as training images and patches corresponding to outputs as ground-truth images.

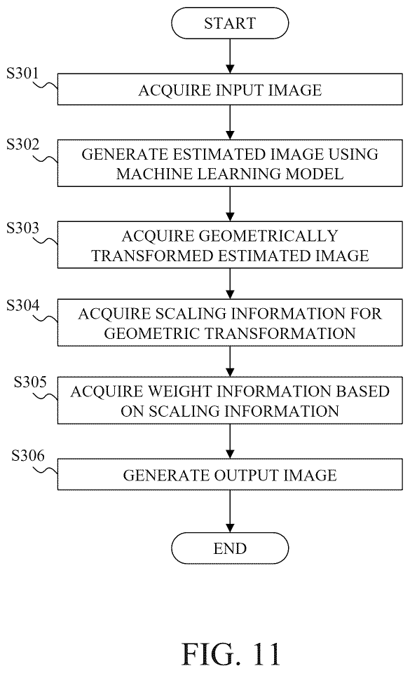

Hereinafter, an image processing method using the trained machine learning model will be described. FIG. 10 is a diagram illustrating a flow of generation of the fourth image (estimation phase) according to the present embodiment. FIG. 11 is a flowchart illustrating generation of the fourth image according to the present embodiment. Each step in FIG. 11 is performed by the acquiring unit 203b, the generator 203c, the estimator 203d, and the adjuster 203e.

In step S301, the acquiring unit 203b acquires an input image (a first image) 41. In the present embodiment, the input image (the first image) 41 is an image captured by the optical system 202a and the image sensor 202b, and is represented using an equisolid angle projection method. The optical system 202a uses a fisheye lens and adopts the equisolid angle projection method.

In step S302, the estimator 203d generates an estimated image (a second image) 42 by inputting the input image (the first image) 41 to the machine learning model. The second image 42 is an image in which blur of the first image 41 is reduced.

In step S303, the generator 203c geometrically transforms the second image 42 represented using the equisolid angle projection method into a coordinate system represented using a central projection method. The geometrically transformed second image obtained here is an image whose blur has been reduced by the machine learning model, but image quality degradation occurs due to enlargement or reduction caused by the geometric transformation. For example, in regions enlarged by the geometric transformation, sharpness is reduced, and in regions reduced by the geometric transformation, a false structure occurs. Image quality degradation caused by the geometric transformation tends to occur strongly in regions where scaling by the geometric transformation is large.

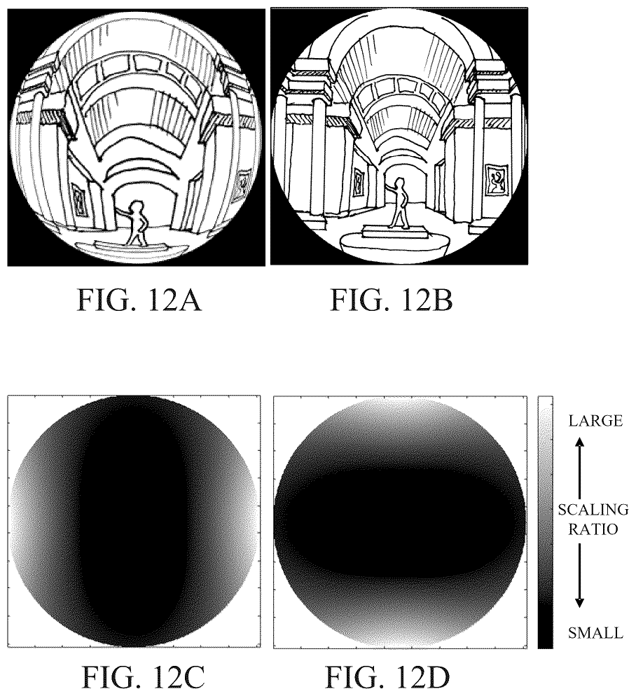

In step S304, the generator 203c generates scaling information 44 in the geometric transformation performed in step S303. The scaling information 44 in the present embodiment includes two types of two-dimensional maps indicating scaling ratios in a horizontal direction and a vertical direction accompanying the geometric transformation from the equisolid angle projection method to the central projection method. The scaling information 44 will be described with reference to FIGS. 12A to 12D. FIG. 12A illustrates an example of the second image 42 represented using the equisolid angle projection method. FIG. 12B illustrates an example of a geometrically transformed second image 43 represented using the central projection method. FIG. 12C is a two-dimensional map indicating a deformation amount in the horizontal direction when the geometrically transformed second image 43 is generated from the second image 42. FIG. 12D is a two-dimensional map indicating a deformation amount in the vertical direction when the geometrically transformed second image 43 is generated from the second image 42. In the present embodiment, the two types of two-dimensional maps illustrated in FIGS. 12C and 12D are the scaling information 44. A method for generating the scaling information 44 is similar to that of the scaling information 23 in the first embodiment. Steps S303 and S304 in the present embodiment may be processed simultaneously.

In step S305, the adjuster 203e acquires weight information 45 based on the scaling information 44. The weight information may be acquired using a method similar to that in step S205 of the first embodiment. In regions where enlargement indicated by the scaling information is large, a weight of the second image for weighted averaging may be increased. That is, in a case where a scaling ratio caused by the geometric transformation is larger than 1 and a second scaling ratio is larger than a first scaling ratio, a weight of a region of the second image corresponding to the second scaling ratio is larger than a weight of a region of the second image corresponding to the first scaling ratio. The weight of the region of the second image corresponding to the second scaling ratio may have a value larger than 1. Thereby, since an effect of the machine learning model can be enhanced, reduction in sharpness caused by enlargement due to the geometric transformation can be suppressed.

In regions where reduction indicated by the scaling information is large, a weight of the second image may be reduced. That is, in a case where a scaling ratio caused by the geometric transformation is smaller than 1 and a second scaling ratio is smaller than a first scaling ratio, a weight of a region of the second image corresponding to the second scaling ratio is smaller than a weight of a region of the second image corresponding to the first scaling ratio. Thereby, a false structure caused by reduction due to the geometric transformation can be suppressed.

In step S306, the adjuster 203e generates an output image (a fourth image) 47 based on the first image (a third image) 41, the second image 42, and the weight information 45. More specifically, based on the weight information 45 acquired in step S305, the adjuster 203e calculates a weighted average of an image (a third image) 46 obtained by geometrically transforming the first image 41 and the geometrically transformed second image 43.

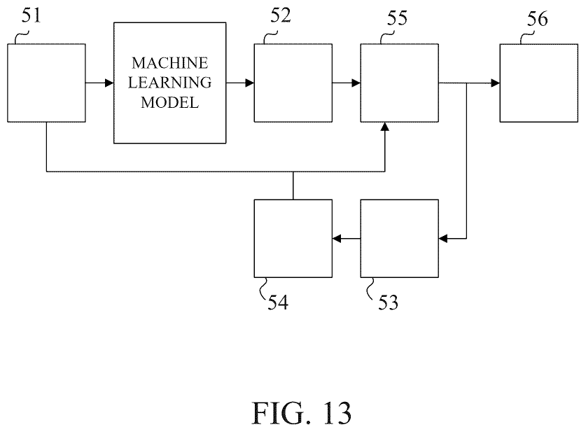

The present embodiment performs the estimation phase according to the flow illustrated in FIG. 10, but may also use the flow illustrated in FIG. 13. In that case, an input image (a first image) 51 is acquired, and a second image 52 is generated by inputting the input image (the first image) 51 to the machine learning model. Scaling information 53 of a geometric transformation is acquired, weight information 54 based on the scaling information 53 is acquired, and a fifth image 55 is generated based on the weight information 54, the first image 51, and the second image 52. An output image (a fourth image) 56 may be generated by geometrically transforming the fifth image 55. In the present embodiment, the second image is an image in which blur is reduced by the machine learning model. However, similarly to the first embodiment, the second image may be a residual image representing a sharpening component. In that case, weight information is applied to the geometrically transformed second image, and the weighted addition is applied to the weighted second image and an image (a third image) obtained by geometrically transforming the first image.

The configuration according to the present embodiment can suppress image quality degradation that occurs when an image processed by a machine learning model is geometrically transformed.

### Third Embodiment

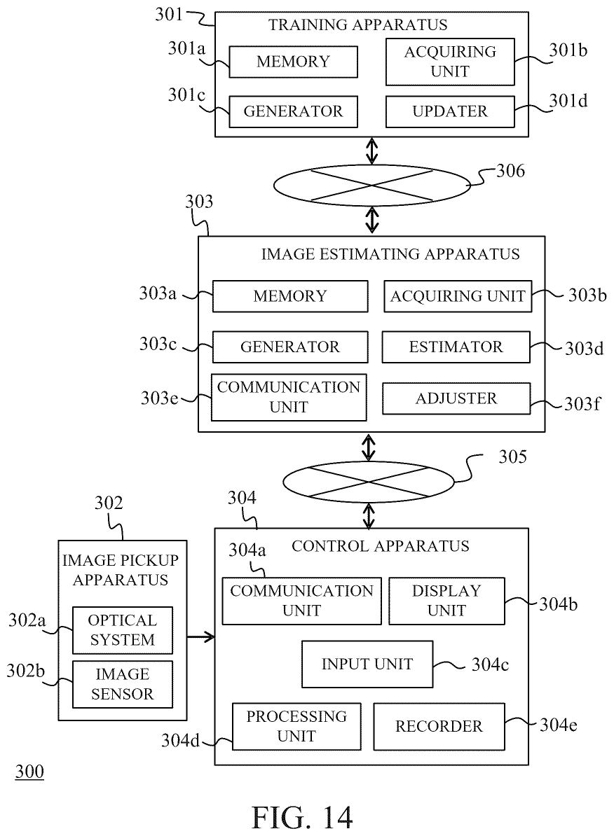

This embodiment causes a machine learning model to train and execute processing for correcting image quality degradation caused by geometric transformation. The image processing system 300 according to this embodiment differs from that of the first embodiment in that it includes a control apparatus 304 that acquires an input image (first image) 21 from an image pickup apparatus 302 and issues a request relating to image processing on the input image (first image) 21 to an image estimating apparatus (image processing apparatus) 303. FIG. 14 is a block diagram of the image processing system 300. The image processing system 300 includes a training apparatus 301, an image pickup apparatus 302, an image estimating apparatus 303, and a control apparatus 304.

In this embodiment, the training apparatus 301 and the image estimating apparatus 303 may be implemented as servers. The control apparatus 304 is a user terminal such as, for example, a personal computer or a smartphone. The control apparatus 304 is connected to the image estimating apparatus 303 via a network 305. The image estimating apparatus 303 is connected to the training apparatus 301 via a network 306. That is, the control apparatus 304 and the image estimating apparatus 303, and the image estimating apparatus 303 and the training apparatus 301, are configured to be communicable with each other.

The training apparatus 301 and the image pickup apparatus 302 have configurations similar to those of the training apparatus 201 and the image pickup apparatus 202, respectively, and thus a description thereof will be omitted.

The image estimating apparatus 303 includes a memory 303a, an acquiring unit 303b, a generator 303c, an estimator 303d, a communication unit (receiver) 303e, and an adjuster 303f. The memory 303a, the acquiring unit 303b, the generator 303c, the estimator 303d, and the adjuster 303f are similar to the memory 203a, the acquiring unit 203b, the generator 203c, the estimator 203d, and the adjuster 203e, respectively.

The control apparatus 304 includes a communication unit (transmitter) 304a, a display unit 304b, an input unit 304c, a processing unit 304d, and a recorder 304e. The communication unit 304a is configured to transmit to the image estimating apparatus 303 a request to execute processing on the input image 21. The communication unit 304a can receive an output image processed by the image estimating apparatus 303. The communication unit 304a may communicate with the image pickup apparatus 302. The display unit 304b displays various types of information. The information displayed by the display unit 304b includes, for example, the input image (first image) 21, a geometrically transformed first image 22, a second image 24, a fourth image 26, or an output image received from the image estimating apparatus 303. The input unit 304c can receive an instruction from a user to start image processing, and the like. The processing unit 304d is configured to perform arbitrary image processing on the output image received from the image estimating apparatus 303. The recorder 304e stores the input image (first image) 21 acquired from the image pickup apparatus 302 and the output image received from the image estimating apparatus 303.

The method of transmitting the input image (first image) 21 to the image estimating apparatus 303 is not limited. For example, the input image 21 may be uploaded to the image estimating apparatus 303 similarly to step S401, or may be uploaded before step S401. Alternatively, the input image (first image) 21 may be an image stored on a server different from the image estimating apparatus 303.

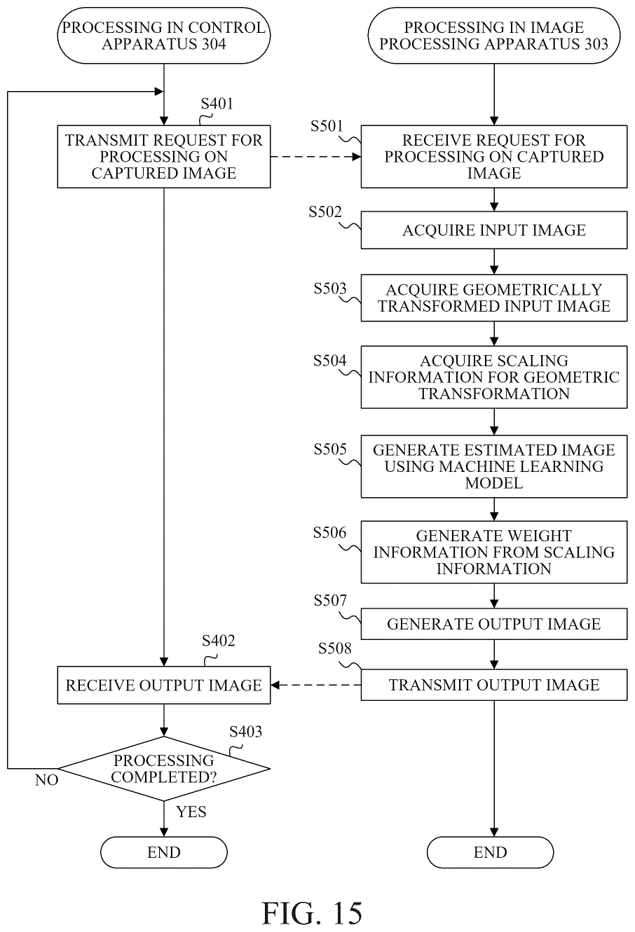

Next, the generation of an output image according to this embodiment will be described. FIG. 15 is a flowchart illustrating the generation of the fourth image in this embodiment.

First, the operation of the control apparatus 304 will be described. In this embodiment, image processing is started according to a user instruction to start image processing via the control apparatus 304.

In step S401 (first transmitting step), the communication unit 304a transmits a request for processing on the input image 21 to the image estimating apparatus 303. In step S401, the control apparatus 304 may transmit, together with the request for processing on the input image (first image) 21, an ID for user authentication, imaging conditions corresponding to the input image 21, and the like.

In step S402 (first receiving step), the communication unit 304a receives the fourth image 26 generated by the image estimating apparatus 303.

Next, the operation of the image estimating apparatus 303 will be described.

In step S501 (second receiving step), the communication unit 303e receives, from the communication unit 304a, the request for processing on the input image (first image) 21. Upon receiving the instruction to process the input image (first image) 21, the image estimating apparatus 303 executes processing from step S502 onward.

In step S502, the acquiring unit 303b acquires the input image (first image) 21. In this embodiment, the input image (first image) 21 is transmitted from the control apparatus 304. The processing of steps S501 and S502 may be performed simultaneously.

Steps S503 through S507 are similar to steps S202 through S206, respectively, and thus a description thereof will be omitted. This embodiment uses image processing method similar to that of the first embodiment, but may use the image processing method according to the second embodiment.

In step S508 (second transmitting step), the image estimating apparatus 303 transmits the fourth image 26 to the control apparatus 304.

As described above, the configuration according to this embodiment can suppress image quality degradation when an image subjected to geometric transformation is processed by a machine learning model.

In this embodiment, the control apparatus 304 merely requests processing for a specific image. The actual image processing is performed by the image estimating apparatus 303. Thus, in a case where the control apparatus 304 is a user terminal, processing load on the user terminal can be reduced. Therefore, the user can obtain an output image with a low processing load.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-066294, filed on Apr. 14, 2025, which is hereby incorporated by reference herein in its entirety.

What is claimed is:

1. An image processing method comprising:
acquiring a first image corresponding to a first coordinate system and first information on scaling in a geometric transformation that converts the first coordinate system into a second coordinate system;
generating a second image based on the first image using a machine learning model; and
generating a fourth image based on second information on a weight based on the first information, the second image, and a third image based on the first image.

2. The image processing method according to claim 1, wherein the second image is an image having a larger number of pixels than the first image or an image obtained by performing sharpening processing on the first image.

3. The image processing method according to claim 1, wherein, in the geometric transformation, a plurality of scaling ratios differ from one another.

4. The image processing method according to claim 1, wherein the first information includes a two-dimensional map indicating a value for each position, and
wherein the second information includes a two-dimensional map corresponding to each pixel of the second image.

5. The image processing method according to claim 1, wherein the first information includes information on scaling corresponding to a plurality of different directions.

6. The image processing method according to claim 1, wherein the fourth image is generated by performing weighted averaging or weighted addition based on the second information, the second image, and the third image.

7. The image processing method according to claim 1, wherein the second information is generated based on the first information.

8. The image processing method according to claim 1, wherein the second information is generated based on a ratio between the first information in two mutually different directions.

9. The image processing method according to claim 1, further comprising:
generating a plurality of weights corresponding to a plurality of different directions based on the first information in the plurality of different directions; and
generating the second information based on the plurality of weights.

10. The image processing method according to claim 1, wherein the second image is generated based on an image obtained by applying the geometric transformation to the first image.

11. The image processing method according to claim 1, wherein the fourth image is generated based on the second image to which the geometric transformation has been applied, the third image to which the geometric transformation has been applied, and the second information.

12. The image processing method according to claim 11, wherein, in a case where a first scaling ratio in the geometric transformation is greater than 1 and a second scaling ratio is greater than the first scaling ratio, a weight of a region of the second image corresponding to the second scaling ratio is greater than a weight of a region of the second image corresponding to the first scaling ratio.

13. The image processing method according to claim 11, wherein, in a case where a first scaling ratio in the geometric transformation is greater than 1 and a second scaling ratio is smaller than the first scaling ratio, a weight of a region of the second image corresponding to the second scaling ratio is smaller than a weight of a region of the second image corresponding to the first scaling ratio.

14. The image processing method according to claim 1, wherein the fourth image is generated by applying the geometric transformation to a fifth image generated based on the second information based on the first information, the second image, and the third image.

15. The image processing method according to claim 1, wherein, in a case where a first scaling ratio in the geometric transformation is greater than 1 and a second scaling ratio is greater than the first scaling ratio, a weight of a region of the second image corresponding to the second scaling ratio is greater than a weight of a region of the second image corresponding to the first scaling ratio.

16. The image processing method according to claim 14, wherein, in a case where a first scaling ratio in the geometric transformation is greater than 1 and a second scaling ratio is smaller than the first scaling ratio, a weight of a region of the second image corresponding to the second scaling ratio is smaller than a weight of a region of the second image corresponding to the first scaling ratio.

17. The image processing method according to claim 1, wherein the third image is generated using a machine learning model different from the machine learning model used to generate the second image.

18. An image processing apparatus comprising:
one or more memories storing instructions; and
one or more processors that, upon execution of the instructions, operate to:
acquire a first image corresponding to a first coordinate system and first information on scaling in a geometric transformation that converts the first coordinate system into a second coordinate system;
generate a second image based on the first image using a machine learning model; and
generate a fourth image based on second information on a weight based on the first information, the second image, and a third image based on the first image.

19. An image processing system comprising:
the image processing apparatus according to claim 18; and
a control apparatus communicable with the image processing apparatus,
wherein the control apparatus includes a transmitter configured to transmit a request for causing the image processing apparatus to execute processing on the first image, and
wherein the image processing apparatus includes a receiver configured to receive the request, and executes the processing on the first image according to the request.

20. A non-transitory computer-readable storage medium storing a program that causes a computer to execute the image processing method according to claim 1.
